(19) United States
(12) Patent Application Publication
(10) Pub. No.: US 2020/0211352 A1
(43) Pub. Date: Jul. 2, 2020

(54) PORTABLE SMOKE, HEAT AND CARBON MONOXIDE DETECTOR

(71) Applicant: John Biship, Santa Ana, CA (US)

(72) Inventor: John Biship, Santa Ana, CA (US)

(21) Appl. No.: 16/721,808

(22) Filed: Dec. 19, 2019

Related U.S. Application Data
(60) Provisional application No. 62/785,645, filed on Dec. 27, 2018.

(51) Int. Cl. G08B 17/117; H04W 4/38

(52) U.S. Cl. CPC G08B 17/117; H04W 4/38

(57) ABSTRACT

The present invention provides apparatus in which a portable device includes a portable telescoping rod coupled with a smoke detector 4 feet higher than a carbon monoxide detector, maximizing the capability of detecting smoke and carbon monoxide. A major advantage of the present invention is the portability of the detectors, such that a user can easily and immediately take and set the device to a target location.

This application claims the benefit of priority of U.S. Provisional Application No. 62/785,645 filed Dec. 27, 2018. These and all other referenced extrinsic materials are incorporated herein by reference in their entirety.

### FIELD OF THE INVENTION

The field of the invention relates generally to portable alarm systems.

### BACKGROUND

The background description includes information that may be useful in understanding the present invention. It is not an admission that any of the information provided herein is prior art or relevant to the presently claimed invention, or that any publication specifically or implicitly referenced is prior art.

America's fire death rate is one of the highest in the industrialized world. Fire kills approximately 4,000 and injures approximately 20,000 people each year. The majority of deaths occur in homes without a working smoke detector. In fact, the Department of Homeland Security's Emergency Management Agency highly recommends homeowners to install working smoke detectors in each room inside of their home.

Many older homes don't have smoke alarms where needed, and the residents may consider it too difficult or expensive to install permanent alarms. U.S. Pat. No. 4,949,077 (Mbuthia) discloses a portable smoke detector designed to be positioned on the floor, however, that solution is lacking because smoke tends to accumulate close to the ceiling. It is therefore questionable whether Mr. Mbuthia's solution would be sufficient to detect a hazardous condition at an early stage of a fire.

A carbon monoxide detector is also useful to identify hazardous conditions. For example, at the early stages of a fire, carbon monoxide is sometimes more prevalent than smoke. U.S. Pat. No. 6,753,786 (Apperson et al.) seeks to address this issue by teaching a combined smoke and the monoxide detector. Although convenient to handle, a combined unit is suboptimal because smoke tends to accumulate the upper parts of a room, while carbon monoxide tends to accumulate at lower parts of a room.

The '077 and '786 patents, as well as any other publications referenced herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved portability and sensitivity to detect a hazardous condition using smoke and monoxide detectors.

### SUMMARY OF THE INVENTION

The inventive subject matter provides apparatus and systems in which a portable device combines a smoke detector positioned (or is positionable) significantly higher than a monoxide detector.

A portable safety device is configured to be assembled with a carbon monoxide detector, a smoke detector, and a support. The carbon monoxide detector is positioned at least 4 feet lower than the smoke detector because carbon monoxide is likely to stay the lower level than the smoke does. In another embodiment, the portable safety device is configured to includes a heat sensor, instead of having the smoke detector or in addition to the smoke detector, positioned at least 4 feet above the carbon monoxide detector because heat usually flows to higher place.

The support further includes a stand and a rod. In one embodiment, the stand is configured to have a flat table at the top of stand, such that the carbon monoxide detector can sit on the top of the table. The stand has at least first, second, and third legs to position the safety device securely. At least one of the legs can be adjustable in its length to incorporate uneven surface to stand securely.

The rod can be extendable including at least partially a telescoping or a multi-jointed rod, allowing to store the rod in less space, and reaching to higher place upon full extension of the rod. The rod is configured to position the smoke detector close to the top end of the rod, for example, positioned within 6 inches of the top of the rod. Because the rod is extended at least 7 feet, the smoke detector can be positioned at least 6 feet above the floor.

One embodiment can be configured to couple both the smoke detector and the carbon monoxide detector on the rod with the carbon monoxide detector positioned no more than 2 feet from a bottom of the rod. Coupling of the smoke and carbon monoxide detectors to the rod can be accomplished in any suitable manner, using screws, anchors, nails, bolts, or a flexible hanging rod/cord, or tape.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In one embodiment, the top or the side portion of the rod, cord, or tape to be outfitted with a ceiling or a side wall using a connector, including for example, hooks, anchors, screws, bolts, a flexible hanging rod/cord, or tape. Thus, minimum components in the device is carbon monoxide detector, smoke detector, and the rod without the stand.

At least one of the carbon monoxide and the smoke detectors is user-detachable from telescoping rod.

In one embodiment, the portable safety device is configured to include an alarm to produce a person-audible sound when triggered by at least one of the carbon monoxide and the smoke detectors. In another embodiment, the portable safety device is configured to include an electronic circuitry to send a wireless signal to a user's cellular phone when triggered by at least one of the carbon monoxide and the smoke detectors.

At least one of the carbon monoxide detector, the smoke detector, the sound, and the wireless signal is manually turned on and off, such that a user can stop monitoring when the user does not want to monitor the space using the safety device.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of a portable safety device.

FIG. 2A is a perspective view of a rod used in FIG. 1 in one embodiment.

FIG. 2B is a perspective view of a rod used in FIG. 1 in another embodiment.

FIG. 3 is a perspective view of a stand used in FIG. 1.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

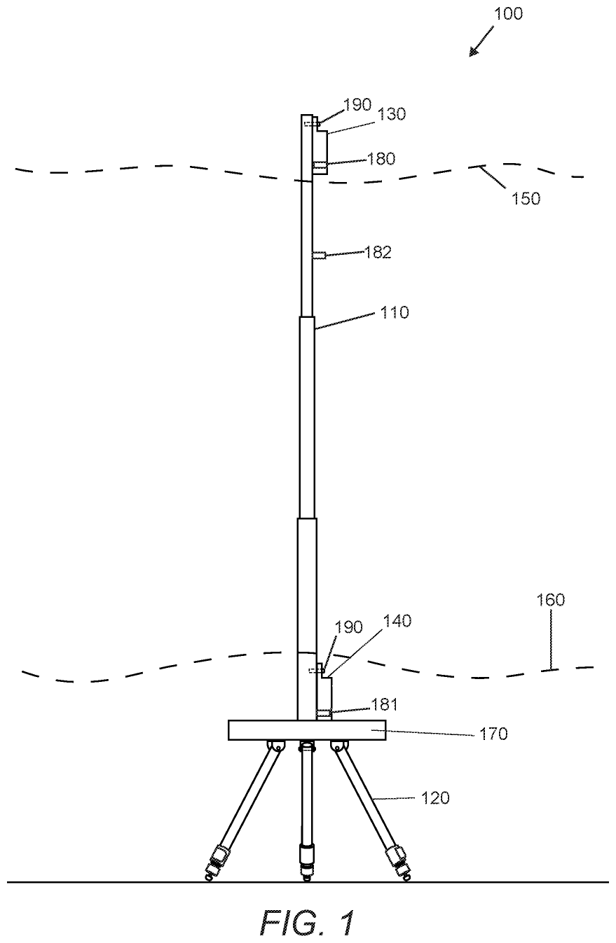

FIG. 1 illustrates a generalized portable safety device 100 of the inventive subject matter. A stand 170 having at least three legs 120 is used to support a telescoping rod 110. A smoke detector 130 is coupled to the rod at a relatively high position, and a carbon monoxide detector 140 is coupled to the rod at a relatively low position. Coupling of the smoke and carbon monoxide detectors can be accomplished in any suitable manner, using screws, anchors, nails, bolts, or any other fasteners 190.

A major advantage of the present invention is portability of the detectors. A user can take the telescoping rod with the detectors to a bedroom, kitchen, playroom, garage, storage area, or any other location where the device might be useful. In addition, in some embodiments each of the detectors can be user-detachable from, and deployed independently from, the rod. As used herein a reference to the detector being “user-detachable” from the rod means that a user can detach the detector from the rod by hand, with no tools at all, or using only a screwdriver, wrench, or pliers.

In one embodiment, the detector can be manually turned on and off, such that a user can choose whether the space should be monitored by the detectors.

In other contemplated embodiments, the rod can depend from a hanging rod/cord or tape, and therefore avoid having a floor stand altogether. One option is for the top and/or side portion of the rod, cord, or tape to be outfitted with a ceiling or side wall connector, including for example, a hook, screw, or bolt.

It is highly advantageous for the smoke detector 130 to be positioned at least 4 feet higher than the carbon monoxide detector 140. This distance is important because smoke 150 generally accumulates near the ceiling as shown in FIG. 1. On the other hand, carbon monoxide 160 has a weight similar to that of nitrogen (78% in air) and heavier than oxygen (20% in air), and therefore carbon monoxide 160 accumulates relatively low in a room. Accordingly, for normal sized rooms having ceilings at least 8 feet tall, the smoke detector 130 should be positioned at least four feet higher than the carbon monoxide detector 140. Also, the carbon monoxide detector should be placed no higher than 4 feet from the floor, and preferably no higher than 2 feet from the floor.

It is also contemplated that an optional heat detector 135 could be utilized instead of, or in addition to, the smoke detector 130.

Alarms can be provided in any suitable manner, either locally through sound and/or light, or distally through cell phone or other electronic communication. In one embodiment, each of the smoke and carbon monoxide detectors has an independent alarm 180, 181. In other embodiments the smoke and carbon monoxide detectors can be coupled to activate a common alarm 182.

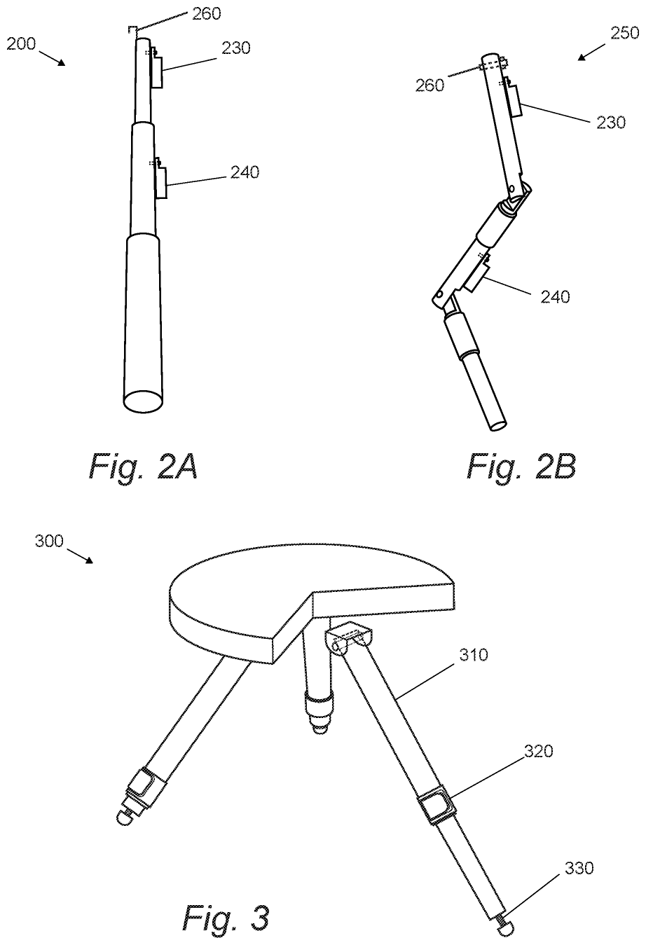

FIG. 2A illustrates a telescoping rod 200. In preferred embodiments, the telescoping rod can cooperate with the optional stand 170 and legs 120, to extend to a height of at least 7 feet above the floor. In preferred embodiments, the top portion of the rod is outfitted with a ceiling or side wall connector, including for example, a hook 260, screw, or bolt. Alternatively, the top end of the telescoping rod could be spring loaded, where force exerted by the spring(s) could hold the rod in place by pushing against both ceiling and floor.

The smoke detector 230 is preferably positioned within at least 6 inches of the top of the telescoping rod. As described above, the carbon monoxide detector 240 positioned at least 4 feet below the smoke detector 230, which might or might not be near the base of the rod.

FIG. 2B illustrates an alternative embodiment of a telescoping rod, a multi-jointed rod 250. As described above, the carbon monoxide detector 240 positioned at least 4 feet below the smoke detector 230.

FIG. 3 illustrates a stand 300, with one of the legs 310 having an adjustable length. In this particular embodiment, the length of the leg can be adjusted to incorporate uneven surface to secure the stand. The stand further has a table, being able to couple the carbon monoxide detector on the table as shown in FIG. 1. In other embodiments, the carbon monoxide detector can be couples with the side of the stand or even with the leg. The legs can be opened to secure the stand position and closed to store in less space.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A portable safety device, comprising:
a carbon monoxide detector;
a smoke detector;
a support coupling the carbon monoxide detector and the smoke detector, wherein the carbon monoxide detector is positioned at least 4 feet lower than the smoke detector.

2. The portable safety device of claim 1, further including a support comprising a stand and a telescoping rod.

3. The portable safety device of claim 2, wherein the stand has at least first, second, and third legs.

4. The portable safety device of claim 3, wherein at least one of the legs is adjustable in length.

5. The portable safety device of claim 1, wherein when the support is positioned on a floor, the telescoping rod cooperate to position the smoke detector to a height at least 6 feet above the floor.

6. The portable safety device of claim 1, wherein the telescoping rod extends to at least 7 feet.

7. The portable safety device of claim 1, wherein the carbon monoxide detector is positioned no more than 2 feet from a bottom of the telescoping rod.

8. The portable safety device of claim 1, wherein the smoke detector is positioned within 6 inches of a top of the telescoping rod.

9. The portable safety device of claim 1, wherein at least one of the carbon monoxide detector and the smoke detector is user-detachable from telescoping rod.

10. The portable safety device of claim 1, wherein the support comprises a telescoping rod from which depend the carbon monoxide detector and the smoke detector.

11. The portable safety device of claim 11, further comprising an anchor which outfits the telescoping rod with a ceiling or side wall.

12. The portable safety device of claim 1, wherein the support comprises a flexible cord from which depend the carbon monoxide detector and the smoke detector.

13. The portable safety device of claim 1, wherein the support comprises a multi-jointed rod from which depend the carbon monoxide detector and the smoke detector.

14. The portable safety device of claim 1, further comprising an alarm configured to produce a person-audible sound when triggered by at least one of the carbon monoxide detector and the smoke detector.

15. The portable safety device of claim 1, further comprising an electronic circuitry configured to send a wireless signal when triggered by at least one of the carbon monoxide detector and the smoke detector.

16. The portable safety device of claim 1, further comprising a heat sensor positioned at least 4 feet above the carbon monoxide detector.

17. The portable safety device of claim 1, wherein at least one of the carbon monoxide detector, the smoke detector, the sound, and light are manually turned on and off.
